(19) United States
(12) Patent Application Publication
(10) Pub. No.: US 2014/0283025 A1
(43) Pub. Date: Sep. 18, 2014

(54) SYSTEMS AND METHODS FOR MONITORING ACTIVITY WITHIN RETAIL ENVIRONMENTS USING NETWORK AUDIT TOKENS

(71) Applicant: TOSHIBA GLOBAL COMMERCE SOLUTIONS HOLDINGS CORPORATION, Research Triangle Park, NC (US)

(72) Inventors: Adrian X. Rodriguez, Durham, NC (US); Dean F. Herring, Youngsville, NC (US); Brad M. Johnson, Raleigh, NC (US); Jeffrey J. J. Smith, Raleigh, NC (US)

(73) Assignee: Toshiba Global Commerce Solutions Holdings Corporation, Research Triangle Park, NC (US)

(21) Appl. No.: 13/804,926

(22) Filed: Mar. 14, 2013

(51) Int. Cl. H04L 12/26

(52) U.S. Cl. CPC H04L 43/10
USPC 726/22; 709/224

(57) ABSTRACT

Systems and methods for monitoring activity within retail environments using network audit tokens are disclosed herein. According to an aspect, a method may include using a processor and memory of a first computing device for determining information associated with an activity of the first computing device within a network environment. The method also includes receiving a network audit token from a second computing device within the retail environment. Further, the method includes communicating the information associated with the activity to a third computing device in response to receipt of the network audit token.

### BACKGROUND

1. Field of the Invention

The present invention relates to retail environments, and more specifically, to monitoring activity within retail environments using network audit tokens.

2. Description of Related Art

In retail environments, such as grocery stores and other “brick and mortar” stores, shoppers generally behave or conduct their activities in the same way. For example, shoppers typically move about the environment in generally the same pattern. Such movements usually include moving through an entrance, aisles, a checkout area, and an exit of the retail environment. Shopper movement can sometimes deviate from the pattern of other shoppers. In most cases when a shopper's movement deviates from the general pattern, his or her activity is only for a purpose of a normal shopping activity. For example, the shopper may spend a long time looking at an item, because he or she is considering a purchase of the item. In other cases, the shopper's activity may not be for a normal shopping activity. For example, he or she may be a shoplifter. For at least this reason, it is desired to recognize abnormal activities of shoppers within retail environment such that attention may be drawn to the activity or preventive action may be taken.

### BRIEF SUMMARY

Systems and methods for monitoring activity within retail environments using network audit tokens are disclosed herein. According to an aspect, a method may include using a processor and memory of a first computing device for determining information associated with an activity of the first computing device within a network environment. The method also includes receiving a network audit token from a second computing device within the retail environment. Further, the method includes communicating the information associated with the activity to a third computing device in response to receipt of the network audit token.

According to another aspect, a method may include using a processor and memory of a first computing device for associating a network audit token with a plurality of computing devices within a retail environment. Further, the method may include receiving the network audit token and information associated with activities of the plurality of computing devices. The method may also include analyzing the information associated with the activities of the plurality of computing devices for detecting an abnormal consumer activity within the retail environment in response to receipt of the network audit token.

According to another aspect, a method may include using a processor and memory of a first computing device for receiving information associated with an activity of a second computing device within a retail environment. The method may also include determining whether the second computing device and a third computing device meet a predetermined proximity requirement. Further, the method may include permitting receipt of information associated with an activity of the third computing device for analyzing the information to detect abnormal consumer activity within the retail environment in response to determining that the second and third computing devices meet the predetermined proximity requirement.

### BRIEF DESCRIPTION OF THE SEVERAL VIEWS OF THE DRAWINGS

FIG. 1 is a block diagram of a system 100 for monitoring activity within a retail environment using network audit tokens according to embodiments of the present invention;

FIG. 2 is a flowchart of an example method for monitoring activity within a retail environment using a network audit token in accordance with embodiments of the present invention;

FIG. 3 is a flowchart of an example method for implementation by a server for monitoring activity within a retail environment using a network audit token in accordance with embodiments of the present invention; and

FIG. 4 is a flowchart of an example method for implementation by a server for monitoring activity within a retail environment in accordance with embodiments of the present invention.

### DETAILED DESCRIPTION

Disclosed herein are systems and methods for monitoring activity within retail environments using network audit tokens. In accordance with embodiments of the present invention, a method may be implemented by one or more computing devices located within a retail environment. Alternatively, a subset of the computing devices implementing the disclosed methods may be located within the retail environment, while other computing devices that implement other parts of the method may be located outside of the retail environment. For example, client computing devices and/or other computing operating within the retail environment may operate together with a remote server for implementing methods disclosed herein.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, a server or other computer located within a retail environment and communicatively connected to other computing devices (e.g., point-of-sale (POS) equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. A computing device can also include any type of conventional computer, for example, a laptop computer or a tablet computer. A typical mobile computing device is a wireless data access-enabled device (e.g., an iPHONE® smart phone, a BLACKBERRY® smart phone, aNEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

The presently disclosed invention is now described in more detail. For example, FIG. 1 illustrates a block diagram of a system 100 for monitoring activity within a retail environment, including areas A102 and B 104, using network audit tokens according to embodiments of the present invention. The system 100 may be implemented in whole or in part in any suitable environment for conducting purchase transactions. For example, the system 100 may be implemented in a retail store having a variety of products or items for purchase and one or more POS terminals and security cameras. Customers may carry mobile computing devices (e.g., smartphones or tablet computers) within the retail store. For example, mobile computing devices 1 108 and 2 110 may be carried within the same area 102, such as the same aisle, of a store. Another mobile computing device 3 112 may be carried by a customer within a different area 104, such as a different aisle of the store.

The system 100 may include a server 106 or other computing device configured to manage accounting, purchase transactions, security functions, and other operations of the store. For example, the server 106 may be communicatively connected to POS terminals and security cameras via a communications network 114. The communications network 110 may be any suitable local area network (LAN), either wireless and/or wired. As an example, the server 106 may communicate data with other devices via a WI-FI® connection. The system 100 may include POS terminals, security cameras, and other components, not shown, that are configured to operate within the retail environment, to acquire and process the data, and to communicate the data to the server 106.

The components of the system 100 may each include hardware, software, firmware, of combinations thereof. For example, software residing on a data store or memory of a respective component may include instructions implemented by a processor for carrying out functions disclosed herein. As an example, the server 106 and mobile computing devices 108, 110, and 112 may each include a user interface 116 (e.g., a display such as a touchscreen display), a barcode scanner, and/or other equipment. A POS terminal within the system 100 may be a self-checkout POS terminal or a retail personnel-assisted POS terminal. A POS terminal may also include a suitable network interface for communicating with the network 114. Further, as an example, security cameras may each include an image capture device or other hardware for capturing images or video. In addition, security cameras may each include a suitable network interface for communicating captured image data and/or other data to the network 114. Mobile computing devices 106 may each include hardware (e.g., image capture devices, scanners, user interfaces, and the like) for capture of various data within the retail environment. Further, mobile computing devices 108, 110, and 112 may each include a suitable network interface 118 for communicating captured data to the network 114.

Mobile computing devices 108 and 110 may each include an activity management module 122 configured to implement functions as disclosed herein in accordance with embodiments of the present invention. The activity management module 122 may be implemented with hardware, software, firmware, or combinations thereof. For example, the activity module 122 may include one or more processors and memory. The activity management module 122 may be an application (or “app”) residing on a memory 124 of the mobile computing device and that has been provided by the retailer through download from the server 106 via the network 114. Alternatively, the application may have been downloaded from a web server via Internet connection or any other suitable technique.

The server 106 may include an activity control module 126 configured to implement functions as disclosed herein in accordance with embodiments of the present disclosure. The activity control module 126 may be implemented with hardware, software, firmware, or combinations thereof. For example, the activity control module 126 may include one or more processors and memory.

FIG. 2 illustrates a flowchart of an example method for monitoring activity within a retail environment using a network audit token in accordance with embodiments of the present invention. The method of FIG. 2 is described as being implemented by one or more mobile computing devices and the server 106 shown in FIG. 1, although the method may be implemented by any suitable computing device(s). The method may be implemented by hardware, software, and/or firmware of one or more mobile computing devices and the server 106.

Referring to FIG. 2, the method includes determining 200 information associated with an activity of a first computing device within a retail environment. For example, mobile computing device 1 108 may determine its location within the retail environment. More particularly, for example, mobile computing device 1 108 may include a global positioning system (GPS) receiver 120 configured to receive satellite coordinate information (i.e., latitude and longitude information) for determining its current location. The activity management module 122 may acquire the coordinate information from the GPS receiver 120 for use in determining that the mobile computing device 1 108 is within area A 102 or another area of a retail environment. The activity management module 122 may store information that maps coordinates to identified areas (e.g., area A 102 and area B 104) of the retail environment. Information mapping identified areas to coordinates may be received from the server 106 via the network 114. The activity management module 122 may use the mapping information to determine an area of the retail environment in which the mobile computing device is located 108. An activity of the shopper may be inferred based on this information. For example, if it is determined that the mobile computing device 1 108 is located in a produce aisle, it can be inferred that the shopper carrying the mobile computing device 1 108 is shopping for produce, or just moving through the produce aisle to reach another area of the retail environment.

In another example of determining information associated with an activity of a computing device, the activity management module 122 may determine a movement of a mobile computing device within the retail environment. For example, the activity management module 122 may acquire coordinate information from the GPS receiver 120 for determining movement within the retail environment. The activity management module 122 can determine movement by detecting a change in coordinates over time. For example, by use of coordinate information, the activity management module 122 can determine a speed of the mobile computing device, a direction of movement of the mobile computing device, a time spent within an area of the retail environment, and the like. An activity of the shopper carrying the mobile computing device may be inferred based on these determinations.

An activity of a computing device or user of the computing device may be determined based on any detected change of the device or user. For example, store aisles or floor can be marked in such a way that users can be detected entering or exiting aisles. In another example, loitering in front of end caps, at the deli, or entering the restroom/changing rooms may be detected and be used for determining the device or user's activity.

The method of FIG. 2 includes receiving 202 a network audit token from a second computing device within the retail environment. For example, a single network audit token may be associated with a single activity monitoring session being controlled by the activity control module 126. One or more network audit tokens may be circulated or communicated among mobile computing devices within a network environment. A network audit token may serve as a “ticket” for instructing or authorizing its owner to collect its activity information, such as the information determined in block 200. The activity control module 126 may initiate an activity monitoring session by generating a network audit token and communicating the network audit token to a mobile computing device, such as mobile computing device 1 108. The activity management module 122 of the mobile computing device 1 108 may receive the network audit token via the network 114 and may store the token within memory 124. As an example, the activity management module 122 may be configured to control the network interface 118 to “listen” for token communications from another computing device via the network 114 or another communications network.

In another example of receiving a network audit token, the mobile computing device 1 108 may receive the network audit token from another mobile computing device. For example, the computing device 1 108 may be in close proximity to another mobile computing device within the retail environment. The nearby mobile computing device may have completed its operation with the token and be in a mode for holding the token until it can be communicated to another mobile computing device. In this case, mobile computing device holding the token may seek to communicate the token to another mobile computing device by a suitable wireless communications technique (e.g., BLUETOOTH® communications or near field communications (NFCs)). When the mobile computing devices are in close proximity such that the communication can be established, the holder of the token may communicate the token to the nearby mobile computing device.

The method of FIG. 2 includes communicating 204 the information associated with the activity to a third computing device in response to receipt of the network audit token. For example, the mobile computing device 1 108 may communicate a network audit token 128 to the mobile computing device 2 110 via wireless communication. The activity management module 122 of the mobile computing device 1 108 may control the network interface 118 to communicate the network audit token 128 to the mobile computing device 2 110. In addition, the mobile computing device 1 108 may communicate the information associated with the activity of the mobile computing device 1 108 to the mobile computing device 2 110.

Similar to the mobile computing 1 108, the mobile computing device 2 110 may determine information associated with its activities. Subsequent to receipt of the network audit token 128, the mobile computing device 2 110 may send its information and the information received from the mobile computing device 1 108 and other mobile computing devices to another computing device. Further, the mobile computing device 2 110 may communicate the network audit token to the same computing device. As an example, the network audit token and the information may be communicated to the server 106.

The method of FIG. 2 includes detecting 206, at the third computing device, an abnormal consumer activity associated with one of the computing devices within the retail environment based on the information associated with the first and second computing devices. For example, the activity control module 126 may analyze the activity information of the mobile computing devices 1 108 and 2 110, and may determine an abnormal consumer activity based on activity information. The activity control module 126 may determine whether an activity of one of the computing devices meets predetermined criteria. If it is determined that the activity meets predetermined criteria, the activity control module 126 may determine that a consumer carrying the computing device is conducting an abnormal consumer activity.

Abnormal consumer activity may generally be any activity conducted by a computing device indicative of an abnormal activity by a consumer. The consumer may be carrying the computing device. As an example, a time spent by a computing device within an area of a retail environment may indicate abnormal consumer activity. For example, information about a time spent within an area and identification of the area for multiple computing devices may be communicated along with a network audit token. If a time spent by one of the computing devices deviates a predetermined amount from the others, it may be determined that the consumer carrying the computing device is conducting an abnormal consumer activity.

In another example of an abnormal consumer activity, a mobile computing device may be used to scan an item for purchase in a particular area of the store. This area may be an unusual area for scanning the item, such as scanning a canned product from one side of the store in the deli. If a mobile computing device scans the item in this area, the activity control module may determine that it is an abnormal consumer activity.

In another example of an abnormal consumer activity, a mobile computing device may be used to scan items at a high rate for purchase of the items. This high rate of scanning may be an unusual. If a mobile computing device scans item at a rate exceeding a predetermined threshold, the activity control module may determine that it is an abnormal consumer activity.

Example abnormal activity may be that items have been moved or misplaced by an associated or customer that changed their mind about the item. For example, a customer may decide not to purchase the item and place it at a nearby and convenient location.

The method of FIG. 2 includes implementing 208, at the third computing device, a predetermined action in response to detecting the abnormal consumer activity. For example, the server 106 may signal an alert, such as on a display of the server 106 or another computing device for indicating the abnormal consumer activity. In addition, identification information of the consumer, such as an image or video of the consumer along with his or her mobile computing device, may be displayed. An example predetermined action may include auditing the consumer at checkout or at his or her exit from the store. For example, if a refrigerated item is scanned outside of the refrigerated section, it may be expired and should not be purchased. Other example actions include alerting associates, offering a sale in an area of suspicious activity, and heightening security at a purchase transaction.

In accordance with embodiments of the present invention, a server or other computing device may generate and control processes related to network audit tokens. As an example, the activity control module 126 of the server 106 shown in FIG. 1 may generate one or more network audit tokens for distribution to mobile computing devices within a retail environment. Each token may be associated with an identifier stored in the memory 124 of the server 106. The token may include an identifier so that it can be matched against the identifier stored in the memory 124.

A token may be communicated to a mobile computing device within a retail environment for beginning an activity monitoring session. For example, when the mobile computing device 1 108 is within the retail environment, server 106 and the device 108 may establish a communication connection via the network 114. The device 108 may be operated by a consumer to register with the server 106. In response to registering with the server 106, the activity control module 126 of the server 106 may determine that the computing device is located within the retail environment. Mobile computing devices of other consumers may be similarly registered with the server 106. In response to determining that the mobile computing device 1 108 is located within the retail environment, the activity control module 126 may communicate a token to the device 108 for assigning an activity monitoring session to the device 108. As a result, the activity monitoring session can begin and the device 108 can monitor and record its activities.

It is noted that there may be customizable policy to designate what to monitor. “Safe” customers may have less monitoring, while “suspicious” customers may have additional monitoring. This information may be associated with the token or adapted over time as the token is passed and compared with activity from other nearby customers.

When the device 108 is in close proximity to another mobile computing device (e.g., mobile computing device 2 110), the device 108 may communicate the token and its activity information to the other mobile computing device. The token and collected activity information of devices receiving the token may be communicated or sent along among multiple mobile computing devices. The token and activity information can be sent to another device when the device is in sufficient proximity to receive the communication. A device holding a token can seek to communicate with other computing devices in order to send the token to the other device. A device without a token may seek to receive a token from another device. Once a communication connection is established between devices, the token and activity information may be exchanged.

Collected activity information and the associated token may be communicated to the server 106 when the activity monitoring session ends. A mobile computing device may determine that the session has ended when the token is requested by the server 106, at the expiration of a time interval, when a user leaves a store, when a user completes a checkout transaction, and the like. Upon receipt of the token and collected activity information at the server 106, the activity control module 126 may match an identifier carried by the token with an identifier stored in the memory 124 of the server 106. Further, the collected activity information may be stored in the memory 124 of the server 106 and associate the information with the token identifier. Example information that may be acquired and communicated to the server includes, but is not limited to, a route the user took in the store, items viewed or stored in front of, time entered, purchases if made, payment information, and the like.

FIG. 3 illustrates a flowchart of an example method for implementation by a server for monitoring activity within a retail environment using a network audit token in accordance with embodiments of the present invention. The method of FIG. 3 is described as being implemented by the server 106 shown in FIG. 1, although the method may be implemented by any suitable computing device(s). The method may be implemented by hardware, software, and/or firmware of the server 106.

Referring to FIG. 3, the method includes associating 300a network audit token with computing devices within a retail environment. For example, the activity control module 126 of the server 106 may initiate an activity monitoring session by generating a network audit token and by communicating the token to a mobile computing device within the retail environment. Subsequent to receipt of the token, the mobile computing device may communicate its activity data and the token to another mobile computing device. The token and acquired activity information may be passed among multiple computing devices within the retail environment in accordance with examples disclosed herein.

The method of FIG. 3 includes receiving 302 the network audit token and information associated with activities of the computing devices. Continuing the aforementioned example, a mobile computing device receiving the token may determine an end to the session. In response to determining the session end, the mobile computing device may communicate the token and acquired activity information to the server 106.

The method of FIG. 3 includes analyzing 304 the information associated with the activities of the computing devices for detecting an abnormal consumer activity within the retail environment. Further, the method of FIG. 3 includes detecting 306 an abnormal activity. Continuing the aforementioned example, the activity control module 126 of the server 106 may analyze received activity information that is associated with a token for detecting an abnormal consumer activity. Abnormal consumer activity may be determined in accordance with examples disclosed herein.

The method of FIG. 3 includes implementing 308 a predetermined action in response to detecting an abnormal activity. Continuing the aforementioned example, the server 106 may signal an alert, such as on a display of the server 106 or another computing device for indicating the abnormal consumer activity. In addition, identification information of the consumer, such as an image or video of the consumer along with his or her mobile computing device, may be displayed. An example predetermined action may include auditing the consumer at checkout or at his or her exit from the store.

In accordance with embodiments of the present invention, a retailer server or other computing device may track consumer mobile computing devices within a retail environment for monitoring activities of the consumers. The server may determine monitor locations of the mobile computing devices for determining when two mobile computing devices are in close proximity to one another. In the case of close proximity, the mobile computing devices may be associated with one another in an activity monitoring session for combining their activity information. As the server determines that other mobile computing devices are in sufficient proximity to any one of the devices associated with a session, the closely positioned mobile computing device may be associated with the session. When a new device is associated with a session, the activity information of the new device may be combined with the activity information of the other devices. This collection of activity information associated with a session may be used for determining abnormal consumer activity in accordance with examples disclosed herein.

FIG. 4 illustrates a flowchart of an example method for implementation by a server for monitoring activity within a retail environment in accordance with embodiments of the present invention. The method of FIG. 4 is described as being implemented by the server 106 shown in FIG. 1, although the method may be implemented by any suitable computing device(s). The method may be implemented by hardware, software, and/or firmware of the server 106.

Referring to FIG. 4, the method includes receiving 400, at a first computing device, information associated with an activity of a second computing device within a retail environment. For example, the mobile computing device 1 108 shown in FIG. 1 may generate activity information and communicate the activity information to the server 106 via the network 114. The activity management module 122 of the mobile computing device 1 108 may register with the server 106 and collect activity information in accordance with example disclosed herein. Prior to leaving the retail environment, the activity management module 122 may control the network interface 118 to communicate the activity information to the server 106.

The method of FIG. 4 includes determining 402 whether the second computing device and a third computing device meet a predetermined proximity requirement. Continuing the aforementioned example, the server 106 may determine location information for each mobile computing device that is registered. Location information may be stored in the memory 124 of the server 106. By use of the location information, the activity control module 126 of the server 106 may determine whether registered devices are located within close proximity. Location information may be provided to the server 106 by the mobile computing devices or by sensors within the retail environment that can detect the mobile computing devices. In an example, the GPS receiver 120 may determine coordinates of the device, and the activity management module 122 may communicate the coordinates and updates to the server 106. The coordinate information may be generalized to associate a position of the device within a defined area of the retail environment (e.g., areas 102 and 104 shown in FIG. 1). The activity control module 126 may determine that mobile computing devices meet the predetermined proximity requirement based on a determined distance between coordinates of the devices, based on whether the devices are located within the same area, or any other suitable technique.

The method of FIG. 4 includes permitting 404 receipt of information associated with an activity of the third computing device for analyzing the information to detect abnormal consumer activity within the retail environment. Receipt of the information may be permitted in response to determining that the second and third computing devices meet the predetermined proximity requirement. Continuing the aforementioned example, the server 106 may receive location information for mobile computing devices 108 and 110. In an example, the activity control module 126 may determine that the devices 108 and 110 are in close proximity if it determines that the devices 108 and 110 are in the same area (e.g., area A 102). In another example, the activity control module 126 may determine that the devices 108 and 110 are in close proximity if it determines that the distance between the devices is less than a predetermined distance. In this example, the distance between the devices may be based on coordinate information for the devices. If the devices are determined to meet the proximity requirement, the activity control module 106 may permit receipt of activity information from the new device (i.e., the device that had not previously sent activity information). When activity information is collected from two or more devise associated with a session, the activity control module 126 may determine an occurrence of abnormal consumer activity and, if so, predetermined action to implement in accordance with examples disclosed herein.

In accordance with embodiments of the present disclosure, abnormal consumer behaviors, such as the aforementioned, can be assigned a score. The scores can be weighted by association with expectation of theft; that is, behaviors most associated with the highest expectation of theft—the highest potential loss—may have the highest scores. These scores may be aggregated over the duration of a shoppers visit, during a subset of their visit, and/or over numerous visits. Scores over a customizable threshold can result in a customizable security procedure that may include alerts to loss prevention personnel and/or audits. This scoring and thresholds can be customized by a retailer and/or based upon a variety of factors, such as the level of trust for a particular shopper, the association between a particular behavior or set of abnormal behaviors and theft, and the monetary value of the order or items most likely to be stolen.

In accordance with embodiments of the present disclosure, activity information may be indicative of characteristics about the retail environment. For example, the activity information may indicate successful placement of items or products within the retail environment. Benefits of obtaining activity information include, but is not limited to, use for changing store layout, placing items in high traffic areas, providing and expiring promotions in order to extend or reduce the amount of time the user is in the store, opening checkout terminals ahead of lines forming, and the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
at a first computing device comprising a processor and memory:
determining information associated with an activity of the first computing device within a retail environment;
receiving a network audit token from a second computing device within the retail environment; and
in response to receipt of the network audit token, communicating the information associated with the activity to a third computing device.

2. The method of claim 1, wherein determining information associated with an activity of the first computing device comprises determining one of a location of the first computing device within the retail environment, a movement of the first computing device within the retail environment, relationship and distance between other tokens, connection with information source, time, movement, and idle time.

3. The method of claim 1, further comprising receiving information associated with an activity of the second computing device.

4. The method of claim 3, further comprising communicating, to the third computing device, the information associated with the activity of the second computing device.

5. The method of claim 1, wherein the third computing device comprises a processor and memory, and
wherein the method further comprises:
at the third computing device:
receiving the information associated with the activity of the first computing device;
receiving information associated with activities of other computing devices within the retail environment; and
analyzing the information associated with the activities of the first computing device and the other computing devices for detecting an abnormal consumer activity within the retail environment.

6. The method of claim 5, further comprising:
at the third computing device:
detecting an abnormal consumer activity associated with one of the computing devices within the retail environment based on the information associated with the activities of the first computing device and the other computing devices; and
in response to detecting the abnormal consumer activity, implementing a predetermined action.

7. The method of claim 6, wherein detecting the abnormal consumer activity comprises detecting whether an activity of the one of the computing devices meets predetermined criteria.

8. The method of claim 7, wherein detecting whether an activity of one of the computing devices meets predetermined criteria comprises determining whether a time spent by the one of the computing devices within an area of the retail environment deviates a predetermined amount from others of the computing devices, and
wherein implementing a predetermined action comprises implementing the predetermined action in response to determining that the time spent deviates the predetermined amount.

9. The method of claim 7, wherein detecting whether an activity of one of the computing devices meets predetermined criteria comprises determining whether an item is scanned within a predetermined area within the retail environment, and
wherein implementing a predetermined action comprises implementing the predetermined action in response to determining that the item is scanned within the predetermined area.

10. The method of claim 7, wherein detecting whether an activity of one of the computing devices meets predetermined criteria comprises determining whether an item is scanned at a rate meeting predetermined criteria, and
wherein implementing a predetermined action comprises implementing the predetermined action in response to determining that the item is scanned at the rate meeting the predetermined criteria.

11. The method of claim 6, wherein implementing a predetermined action alerting associates, offering a sale in an area of suspicious activity, and heightening security at a purchase transaction.

12. A method comprising:
at a first computing device comprising a processor and memory:
associating a network audit token with a plurality of computing devices within a retail environment;
receiving the network audit token and information associated with activities of the plurality of computing devices; and
in response to receipt of the network audit token, analyzing the information associated with the activities of the plurality of computing devices for detecting an abnormal consumer activity within the retail environment.

13. The method of claim 12, further comprising:
determining whether the computing devices are located within the retail environment; and
in response to determining that the computing devices are located within the retail environment:
generating the network audit token; and
communicating the network audit token to a second computing device among the plurality of computing devices.

14. The method of claim 13, further comprising:
at the second computing device:
determining information associated with an activity of the second computing device within the retail environment; and
in response to receipt of the network audit token:
communicating the network audit token to a third computing device among the plurality of computing devices; and
communicating, to the third computing device, information associated with the activity of the second computing device.

15. The method of claim 14, further comprising:
at the first computing device:
receiving information associated with activities of the second and third computing devices;
receiving the network audit token; and
in response to receipt of the network audit token, analyzing the information associated with the activities of the second and third computing devices for detecting an abnormal consumer activity within the retail environment.

16. The method of claim 15, further comprising:
at the first computing device:
detecting an abnormal consumer activity associated with one of the second and third computing devices based on the information associated with the activities of the second and third computing devices; and
in response to detecting the abnormal consumer activity associated with one of the second and third computing devices, implementing a predetermined action.

17. The method of claim 16, wherein detecting an abnormal consumer activity comprises detecting whether an activity of one of the second and third computing devices meets predetermined criteria.

18. The method of claim 17, wherein detecting whether an activity of one of the second and third computing devices meets predetermined criteria comprises determining whether a time spent by the one of the second and third computing devices deviates a predetermined amount from the other of the second and third computing devices, and
wherein implementing a predetermined action comprises implementing the predetermined action in response to determining that the time spent deviates the predetermined amount.

19. The method of claim 17, wherein detecting whether an activity of one of the second and third computing devices meets predetermined criteria comprises determining whether an item is scanned within a predetermined area within the retail environment, and
wherein implementing a predetermined action comprises implementing the predetermined action in response to determining that the item is scanned within the predetermined area.

20. The method of claim 17, wherein detecting whether an activity of one of the second and third computing devices meets predetermined criteria comprises determining whether an item is scanned at a rate meeting predetermined criteria, and
wherein implementing a predetermined action comprises implementing the predetermined action in response to determining that the item is scanned at the rate meeting the predetermined criteria.

21. The method of claim 16, wherein implementing a predetermined action comprises alerting associates, offering a sale in an area of suspicious activity, and heightening security at a purchase transaction.

22. A method comprising:
at a first computing device comprising a processor and memory:
receiving information associated with an activity of a second computing device within a retail environment;
determining whether the second computing device and a third computing device meet a predetermined proximity requirement;
in response to determining that the second and third computing devices meet the predetermined proximity requirement, permitting receipt of information associated with an activity of the third computing device for analyzing the information to detect abnormal consumer activity within the retail environment.

23. The method of claim 22, further comprising:
receiving information associated with the activity of the third computing device within the retail environment; and
analyzing the information associated with the activities of the second and third computing devices to detect the abnormal consumer activity within the retail environment.

24. The method of claim 23, further comprising:
at the third computing device:
detecting an abnormal consumer activity associated with one of the second and third computing devices within the retail environment based on the information associated with the activities of the second and third computing devices; and
in response to detecting the abnormal consumer activity associated with one of the second and third computing devices, implementing a predetermined action.

25. The method of claim 24, wherein detecting the abnormal consumer activity comprises detecting whether an activity of one of the second and third computing devices meets predetermined criteria.

26. The method of claim 25, wherein detecting whether an activity of one of the second and third computing devices meets predetermined criteria comprises determining whether a time spent by the one of the second and third computing devices within an area of the retail environment deviates a predetermined amount from the other of the second and third computing devices, and
wherein implementing a predetermined action comprises implementing the predetermined action in response to determining that the time spent deviates the predetermined amount.

27. The method of claim 25, wherein detecting whether an activity of one of the second and third computing devices meets predetermined criteria comprises determining whether an item is scanned within a predetermined area within the retail environment, and
wherein implementing a predetermined action comprises implementing the predetermined action in response to determining that the item is scanned within the predetermined area.

28. The method of claim 25, wherein detecting whether an activity of one of the second and third computing devices meets predetermined criteria comprises determining whether an item is scanned at a rate meeting predetermined criteria, and
wherein implementing a predetermined action comprises implementing the predetermined action in response to determining that the item is scanned at the rate meeting the predetermined criteria.

29. The method of claim 24, wherein implementing a predetermined action alerting associates, offering a sale in an area of suspicious activity, and heightening security at a purchase transaction.

30. A computing device comprising:
a processor and memory; and
an activity management module configured to:
determine information associated with an activity of a first computing device within a retail environment;
receive a network audit token from a second computing device within the retail environment; and
communicate the information associated with the activity to a third computing device in response to receipt of the network audit token.

31. A computing device comprising:
a processor and memory; and
an activity control module configured to:
associate a network audit token with a plurality of computing devices within a retail environment;
receive the network audit token and information associated with activities of the plurality of computing devices; and
analyze the information associated with the activities of the plurality of computing devices for detecting an abnormal consumer activity within the retail environment in response to receipt of the network audit token.

32. A computing device comprising:
a processor and memory; and
an activity control module of a first computing device configured to:
receive information associated with an activity of a second computing device within a retail environment;
determine whether the second computing device and a third computing device meet a predetermined proximity requirement;
permit receipt of information associated with an activity of the third computing device for analyzing the information to detect abnormal consumer activity within the retail environment in response to determining that the second and third computing devices meet the predetermined proximity requirement.

33. A computer program product for monitoring activity within a retail environment, said computer program product comprising:
a non-transitory computer readable storage medium having computer readable program code embodied therewith, the computer readable program code comprising:
computer readable program code configured to determine information associated with an activity of a first computing device within a retail environment;
computer readable program code configured to receive a network audit token from a second computing device within the retail environment; and
computer readable program code configured to communicate the information associated with the activity to a third computing device in response to receipt of the network audit token.

34. A computer program product for monitoring activity within a retail environment, said computer program product comprising:
a non-transitory computer readable storage medium having computer readable program code embodied therewith, the computer readable program code comprising:
computer readable program code configured to associate a network audit token with a plurality of computing devices within a retail environment;
computer readable program code configured to receive the network audit token and information associated with activities of the plurality of computing devices; and
computer readable program code configured to analyze the information associated with the activities of the plurality of computing devices for detecting an abnormal consumer activity within the retail environment in response to receipt of the network audit token.

35. A computer program product for monitoring activity within a retail environment, said computer program product comprising:
a non-transitory computer readable storage medium having computer readable program code embodied therewith, the computer readable program code comprising:
computer readable program code configured to receive, at a first computing device, information associated with an activity of a second computing device within a retail environment;
computer readable program code configured to determine whether the second computing device and a third computing device meet a predetermined proximity requirement;
computer readable program code configured to permit receipt of information associated with an activity of the third computing device for analyzing the information to detect abnormal consumer activity within the retail environment in response to determining that the second and third computing devices meet the predetermined proximity requirement.
